(19) United States
(12) Patent Application Publication
(10) Pub. No.: US 2013/0322449 A1
(43) Pub. Date: Dec. 5, 2013

(54) APPARATUS AND METHOD FOR PROVIDING PARTIAL NETWORKING SUPPORT FOR VEHICLE AND ELECTRONIC CONTROL UNIT INCLUDING THE APPARATUS

(71) Applicant: Electronics and Telecommunications Research Institute, Daejeon-si (KR)

(72) Inventors: Hyun-Yong HWANG, Daejeon-si (KR); Tae-Man HAN, Daejeon-si (KR)

(21) Appl. No.: 13/904,667

(22) Filed: May 29, 2013

(30) Foreign Application Priority Data
May 30, 2012 (KR) 10-2012-0057673

(51) Int. Cl. H04L 12/723

(52) U.S. Cl. CPC H04L 45/50
USPC 370/392

(57) ABSTRACT

An apparatus and method for providing partial networking support for a vehicle, and an electronic control unit including the apparatus. The apparatus includes a service ID extraction unit configured to extract service ID information from a controller area network (CAN) frame or an Ethernet frame; a table search unit configured to search a predefined partial network table for service information and network information corresponding to the service ID information; a frame generation unit configured to generate a partial networking Ethernet frame based on the found service information; and a frame transmission unit configured to transmit the generated partial networking Ethernet frame to a network based on the found network information.

### CROSS-REFERENCE TO RELATED APPLICATION

This application claims the benefit under 35 U.S.C. §119(a) of Korean Patent Application No. 10-2012-0057673, filed on May 30, 2012, the entire disclosure of which is incorporated herein by reference for all purposes.

### BACKGROUND

1. Field

The following description relates to an automotive network apparatus, and more particularly, to an apparatus and method for providing partial networking support for a vehicle and an electronic control unit (ECU) including the apparatus.

2. Description of the Related Art

Recently, cars, traditionally regarded only as transportation for people and goods, are increasingly used as infotainment (Information+Entertainment) systems, which are capable of providing users with information and entertainment. To support such infotainment, a control area network (CAN) for supporting automotive multimedia services requires use of general data services and data from a packet network that offers a new type of multimedia service.

An automotive network comprises a number of electronic control units (ECUs), which are included in various domains of a vehicle, depending on types of services. In a powertrain domain, an ECU is used for an engine control system, a self-diagnosis system and/or an automatic transmission system. In a body domain that focuses on the convenience of use, the ECU is used as a control system of body electronic units, convenience units and lamps. In addition, in a chassis domain that concentrates on safety, the ECU is used for a steering system control, a break control, and a suspension control. Also, in an infotainment domain that offers information and entertainment, the ECU is used for a navigation system, a telematics system and/or a multimedia system. The number of ECUs included in an automotive network has been increased as more convenient units and technologies are adapted to a vehicle. However, once a vehicle is turned on, such ECUs are always activated regardless of the use of services, thus resulting in use of standby power and carbon dioxide emission.

### SUMMARY

The following description relates to an apparatus and method for selectively operating particular electronic control units (ECUs) associated with a given automotive service in a vehicle packet network including a plurality of ECUs, based on a bitmap, which is set in accordance with is the automotive service, and virtual LAN ID and multiprotocol label switching (MPLS) label information, while shutting off the power to unused parts of the ECUs inside a vehicle.

In one general aspect, there is provided an apparatus capable of providing partial networking support for a vehicle, the apparatus including: a service ID extraction unit configured to extract service ID information from a controller area network (CAN) frame or an Ethernet frame; a table search unit configured to search a predefined partial network table for service information and network information corresponding to the service ID information; a frame generation unit configured to generate a partial networking Ethernet frame based on the found service information; and a frame transmission unit configured to transmit the generated partial networking Ethernet frame to a network based on the found network information.

The predefined partial network table may include service IDs, each indicating a type of service to be offered, a bitmap for representing location information about where an electronic control unit required for provision of service is located on a bus, and VLAN IDs and MPLS labels for data forwarding, the service information searched by the table search unit includes both VLAN ID information and MPLS label information, each of which corresponds to the service ID, and the network information searched by the service information is the location information represented by the bitmap regarding where an ECU is located on a bus.

The frame generation unit may generate a partial networking Ethernet frame based on information about the VLAN ID corresponding to the service ID information in a case of the network using a VLAN service.

The frame generation unit may generate a partial networking Ethernet frame based on information about the MPLS label corresponding to the service ID information in a case of the network using an MPLS service.

The frame generation unit may generate the partial networking Ethernet frame is containing data including E-type data for indicating a type of frame, the VLAN ID for data forwarding and an operation instruction for an ECU.

The frame generation unit may generate the partial networking Ethernet frame containing data including E-type data for indicating a type of frame, the MPLS label for data forwarding and an operation instruction for an ECU.

In another general aspect, there is provided a method of providing partial networking support for a vehicle, the method including: extracting service ID information from a controller area network (CAN) frame or an Ethernet frame; searching a predefined partial network table for both service information and network information corresponding to the service ID information; generating a partial networking Ethernet frame based on the found service information; and transmitting the generated partial networking Ethernet frame to a network based on the found network information.

Other features and aspects will be apparent from the following detailed description, the drawings, and the claims.

### BRIEF DESCRIPTION OF THE DRAWINGS

FIG. 1 is a diagram illustrating an example of a configuration of an apparatus capable of providing partial networking support for a vehicle.

FIG. 2 is a diagram illustrating an example of a partial network table included in an apparatus capable of providing partial networking support for a vehicle.

FIG. 3A is a diagram illustrating an example of a partial networking Ethernet frame with a VLAN ID.

FIG. 3B is a diagram illustrating an example of a partial networking Ethernet frame with an MPLS label.

FIG. 4 is a flowchart illustrating an example of a method of providing partial networking support for a vehicle.

FIG. 5 is a diagram illustrating an example of the application of an apparatus capable of providing partial networking support for a vehicle to an automotive network that uses a VLAN service.

FIG. 6 is a diagram illustrating an example of the application of an electronic control unit (ECU) with an apparatus capable of providing partial networking support for a vehicle to an automotive network that uses a VLAN service and a MPLS service.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

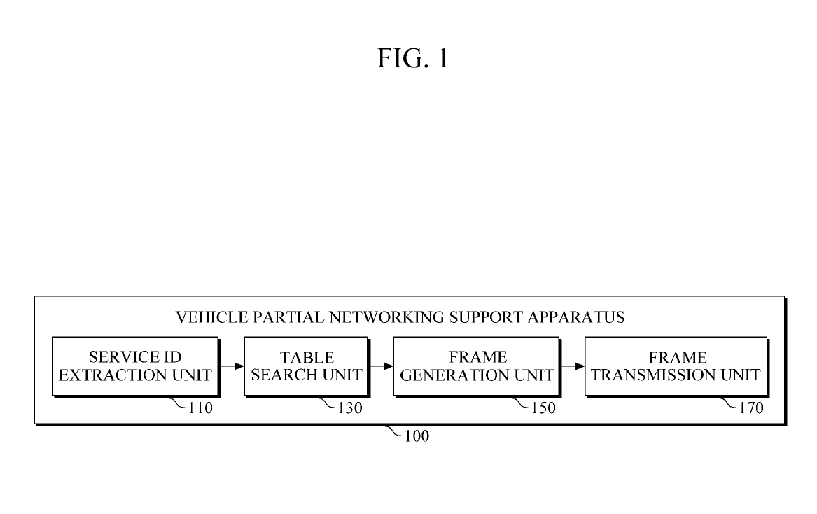

FIG. 1 is a diagram illustrating an example of a configuration of an apparatus capable of providing partial networking support for a vehicle.

Referring to FIG. 1, an apparatus 100 capable of providing partial networking support for a vehicle may include a service ID extraction unit 110, a table search unit 130, a frame generation unit 150, and a frame transmission unit 170.

The service ID extraction unit 110 may extract service ID information from a controller area network (CAN) frame received over a CAN or from an Ethernet frame received over a packet network.

The table search unit 130 may search a predefined partial network table for both service information and network information corresponding to the service ID information. For example, the partial network table may contain service IDs, each indicating a type of service to be offered, a bitmap indicating location information about where an electronic control unit (ECU) required for provision of the service is located on a bus, and virtual LAN (VLAN) ID and multiprotocol label switching (MPLS) label information which are required for forwarding data. The table search unit 130 may search the above partial network table for both the service information and the network information, each of which corresponds to the service ID, wherein the service information includes both the VLAN ID information and MPLS label information and the network information is the location information of the ECU on the bus.

The frame generation unit 150 may generate a partial networking Ethernet frame using the service information found by the table search unit 130. For example, the frame generation unit 150 may generate a partial networking Ethernet frame using the VLAN ID information corresponding to the service ID in the case of a network using VLAN services. Alternatively, in the case of a network using MPLS services, the frame generation unit 150 may generate a partial networking Ethernet frame using the MPLS label information corresponding to the service ID.

The frame transmission unit 170 may transmit the partial networking Ethernet frame generated by the frame generation unit 150 to the network. For example, if the network information found by the table search unit 130 is information about a location of an ECU on a bus, the ECU being required for providing a service, the frame transmission unit 170 may transmit the partial networking Ethernet frame to the relevant ECU based on the location information.

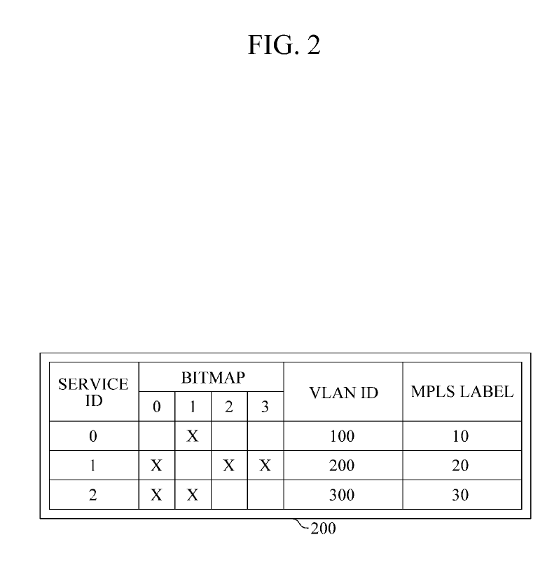

FIG. 2 is a diagram illustrating an example of a partial network table included in an apparatus capable of providing partial networking support for a vehicle.

As shown in FIG. 2, a partial network table 200 may include service IDs, a bitmap, VLAN IDs, and MPLS labels. Each service ID indicates a type of service rendered by a car, and the bitmap indicates information (ECU number) about a location of an ECU on a bus, wherein the ECU is used in providing a service. The VLAN IDs and MPLS labels are used for forwarding a message to the ECU that is required for the provision of the service.

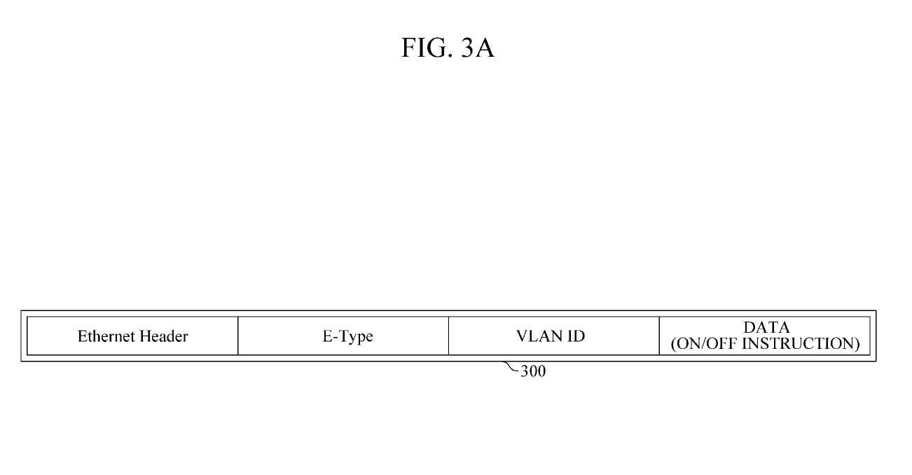

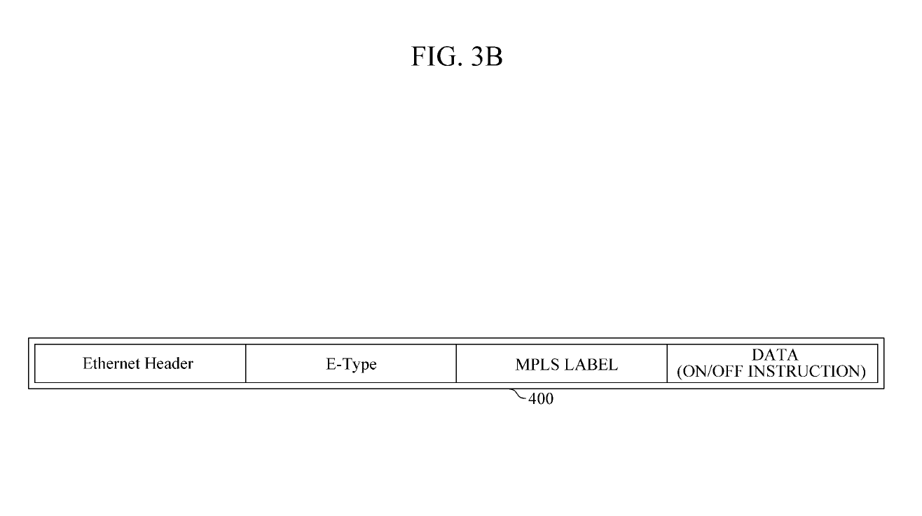

FIG. 3A is a diagram illustrating an example of a partial networking Ethernet frame with a VLAN ID.

As shown in FIG. 3A, a partial networking Ethernet frame 300 with a VLAN ID may consist of an Ethernet header, an E-type, the VLAN ID, and Ethernet data. The Ethernet header includes destination information for the Ethernet frame 300 to be transmitted to a particular ECU associated with an automotive service, and the E-type indicates a type of frame. The VLAN ID for data forwarding is used as a service ID of an automotive service. The Ethernet data may include an ON/OFF instruction to start and/or terminate the operation of the ECU.

FIG. 3B is a diagram illustrating an example of a partial networking Ethernet frame with an MPLS label.

As shown in FIG. 3B, a partial networking Ethernet frame 400 with an MPLS label may consist of an Ethernet header, an E-type, the MPLS label, and Ethernet data. The Ethernet header includes destination information for the Ethernet frame 400 to be transmitted to a particular ECU associated with an automotive service, and the E-type indicates a type of frame. The VLAN ID for data forwarding may be used as a service ID of the automotive service. The Ethernet data may include an ON/OFF instruction to start and/or terminate the operation of the ECU.

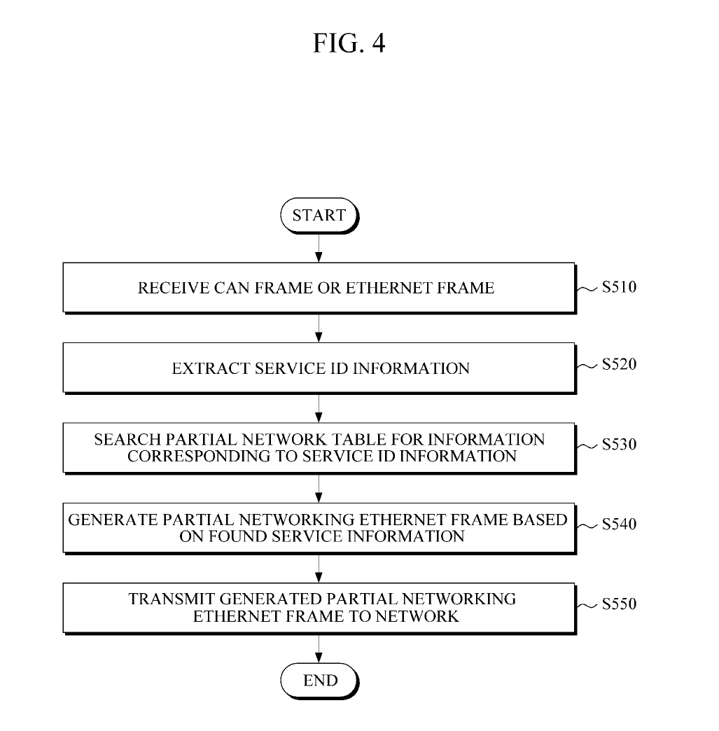

FIG. 4 is a flowchart illustrating an example of a method of providing partial networking support for a vehicle.

Referring to FIG. 4, a CAN frame or an Ethernet frame is received in S510, and then service ID information is extracted from a data area of the received CAN frame or Ethernet frame in S520. Service information and network information corresponding to the extracted service ID information are searched in a predefined partial network table 200 in S530. For example, the partial network table 200 may include service IDs, each indicating a type of service, a bitmap for representing location information about where an ECU required for provision of the service is located on a bus, and VLAN ID and MPLS label which are required for forwarding data. In this case, the service information includes both the VLAN ID information and MPLS label information, each of which correspond to the service ID, and the network information is the location information of the ECU which is represented by the bitmap.

A partial networking Ethernet frame is generated using the found service information in S540. For example, in the case of a network that uses a VLAN service, the partial networking Ethernet frame is generated based on the VLAN ID information corresponding to the service ID, and in the case of a network that uses an MPLS service, the partial networking Ethernet frame is generated based on the MPLS label information.

Thereafter, the generated partial networking Ethernet frame is transmitted to the network based on the found network information in S550. The found network information may be the location information about where the ECU required for provision of the service is located on a bus.

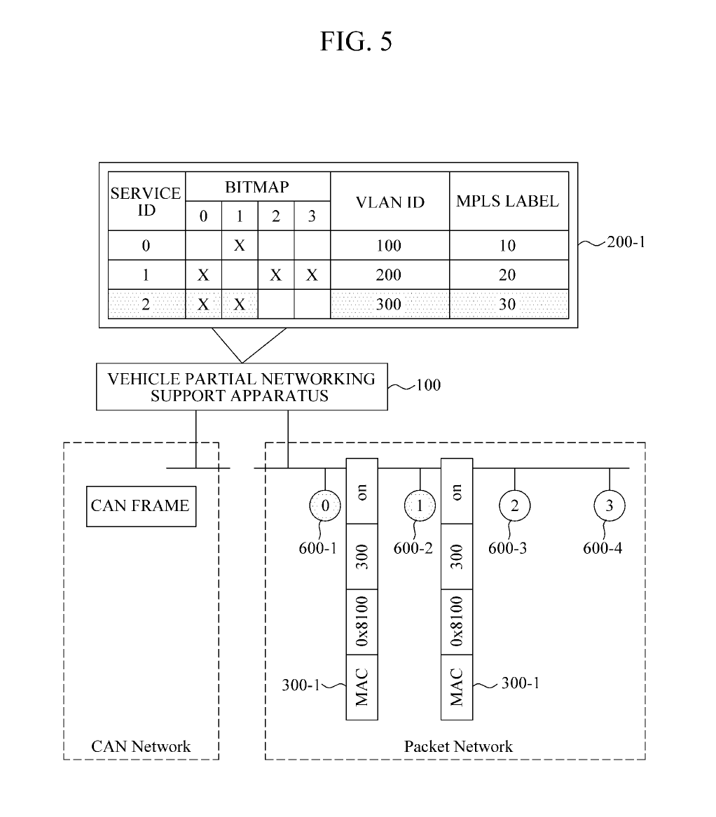

FIG. 5 is a diagram illustrating an example of the application of an apparatus capable of providing partial networking support for a vehicle to an automotive network that uses a VLAN service.

The example illustrated in FIG. 5 assumes that the automotive network uses service 2.

An apparatus 100 capable of providing partial networking support receives a CAN frame from a CAN network, and extracts information about service 2 as service ID information contained in a data area of the CAN frame. The apparatus searches a partial network table 200-1 using the extracted information about service 2. If a packet network connected to the apparatus 100 is a network that uses a VLAN service, the apparatus 100 searches for 0 and 1, as location information about where an ECU required for provision of a service is located on a bus, which is stored in a bitmap associated with each service ID, and VLAN ID 300, as VLAN ID information, and then generates a partial networking Ethernet frame 300-1. In this case, since the partial networking Ethernet frame 300-1 includes the VLAN ID, an E-type of the frame is determined as “0x8100”.

Then, the apparatus 100 transmits the generated partial networking Ethernet frame 300-1 to ECU0 600-1 and ECU1 600-2 located at positions corresponding to the location information, 0 and 1, respectively, each of which indicates where an ECU required for provision of service 2 is located on a bus. Each of ECU0 600-1 and ECU1 600-2 that have received the partial networking Ethernet frame 300-1 extracts an ON/OFF instruction from the data area of the partial networking Ethernet frame 300-1, and is operated in response to the extracted instruction which is ON.

As such, it is possible to selectively operate two ECUs, ECU0 600-1 and ECU1 600-2, from among four ECUs 600-1 to 600-4 located on the network for supporting service 2.

Meanwhile, procedures of the application of the apparatus capable of providing partial networking support to an automotive network that uses an MPLS service are the same as the procedures for the automotive network that uses the VLAN service as described above. However, a partial networking Ethernet frame is generated based on MPLS label information corresponding to a service ID, and since the frame includes an MPLS label, its E-TYPE is determined as “0x8847”.

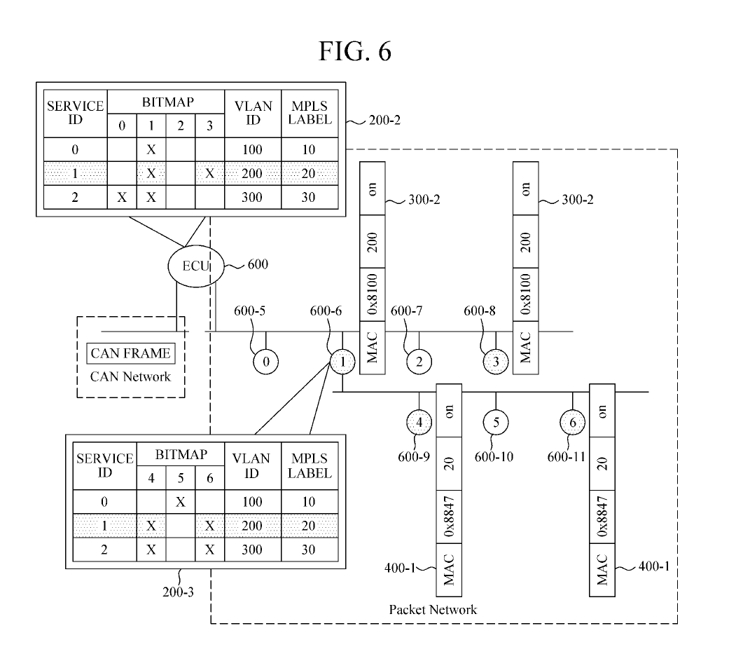

FIG. 6 is a diagram illustrating an example of the application of an electronic control unit (ECU) with an apparatus capable of providing partial networking support for a vehicle to an automotive network that uses a VLAN service and an MPLS service.

The example illustrated in FIG. 6 assumes that the automotive network attempts to use service 1 and every ECU includes an apparatus 100 capable of providing partial networking support for a vehicle.

An ECU 600 receives a CAN frame from a CAN network and extracts service ID information, that is, service 1, which is contained in a data area of the CAN frame. The ECU 600 searches a partial network table 200-2 based on extracted information about service 1. If a network connected to the ECU 600 uses a VLAN service, location information about where an ECU required for provision of service, which is included in a bitmap associated with each service ID, is found as 1 and 3, and VLAN ID information is found as VLAN ID 200. Thereafter, a partial networking Ethernet frame 300-2 is generated. In this case, since the partial networking Ethernet frame 300-2 includes the VLAN ID, its E-type is determined as “0x8100”.

Then, the ECU 600 transmits the generated partial networking Ethernet frame 300-2 to ECU1 600-6 and ECU3 600-8 located at positions corresponding location information, 1 and 3, which indicates where an ECU required for provision of service 1 is located on a bus. Each of ECU1 600-6 and ECU3 600-8 that have received the partial networking Ethernet frame 300-2 extracts an ON/OFF instruction from the data area of the partial networking Ethernet frame 300-2, and then is operated in response to the extracted instruction which is ON.

In addition, since being connected to another packet network, ECU1 600-6 searches a partial network table 200-3 stored therein. If the packet network connected to ECU1 600-6 uses an MPLS service, location information about where an ECU required for provision of service, which is included in a bitmap associated with each service ID, is found as 4 and 6, and MPLS label information is found as MPLS label 20. Afterwards, a partial networking Ethernet frame 400-1 is generated, in which an E-type is determined as “0x8847” since the partial networking Ethernet frame 400-1 includes the MPLS label.

The partial networking Ethernet frame 400-1 generated by ECU1 600-6 is transmitted to ECU4 600-9 and ECU6 600-11 located at positions corresponding to the location information, 4 and 6, respectively, each of which indicates where an ECU required for provision of service 1 is located on a bus. Each of ECU4 600-9 and ECU6 600-11 extracts an ON/OFF instruction from the data area of the partial networking Ethernet frame 400-1 and is operated in response to the extracted instruction which is ON.

That is, it is possible to selectively operate four ECUs, ECU1 600-6, ECU3 600-8, ECU4 600-9, and ECU6 600-11, from among seven ECUs, including ECU0 600-5 to ECU6 600-11, located on the networks for supporting service 1.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

1. An apparatus capable of providing partial networking support for a vehicle, the apparatus comprising:
a service ID extraction unit configured to extract service ID information from a controller area network (CAN) frame or an Ethernet frame;
a table search unit configured to search a predefined partial network table for service information and network information corresponding to the service ID information;
a frame generation unit configured to generate a partial networking Ethernet frame based on the found service information; and
a frame transmission unit configured to transmit the generated partial networking Ethernet frame to a network based on the found network information.

2. The apparatus of claim 1, wherein the predefined partial network table includes service IDs, each indicating a type of service to be offered, a bitmap for representing location information about where an electronic control unit required for provision of service is located on a bus, and VLAN IDs and MPLS labels for data forwarding, the service information searched by the table search unit includes both VLAN ID information and MPLS label information, each of which corresponds to the service ID, and the network information searched by the service information is the location information represented by the bitmap regarding where an ECU is located on a bus.

3. The apparatus of claim 2, wherein the frame generation unit generates a partial networking Ethernet frame based on information about the VLAN ID corresponding to the service ID information in a case of the network using a VLAN service.

4. The apparatus of claim 2, wherein the frame generation unit generates a partial networking Ethernet frame based on information about the MPLS label corresponding to the service ID information in a case of the network using an MPLS service.

5. The apparatus of claim 3, wherein the frame generation unit generates the partial networking Ethernet frame containing data including E-type data for indicating a type of frame, the VLAN ID for data forwarding and an operation instruction for an ECU.

6. The apparatus of claim 4, wherein the frame generation unit generates the partial networking Ethernet frame containing data including E-type data for indicating a type of frame, the MPLS label for data forwarding and an operation instruction for an ECU.

7. A method of providing partial networking support for a vehicle, the method comprising:
extracting service ID information from a controller area network (CAN) frame or an Ethernet frame;
searching a predefined partial network table for both service information and network information corresponding to the service ID information;
generating a partial networking Ethernet frame based on the found service information; and
transmitting the generated partial networking Ethernet frame to a network based on the found network information.

8. The method of claim 7, wherein the predefined partial network table includes service IDs, each indicating a type of service to be offered, a bitmap for representing location information about where an electronic control unit required for provision of service is located on a bus, and VLAN IDs and MPLS labels for data forwarding, the service information searched by the table search unit includes both VLAN ID information and MPLS label information each of which corresponds to the service ID, and the network information searched by the service information is the location information represented by the bitmap regarding where an ECU is located on a bus.

9. The method of claim 8, wherein the generating of the partial networking Ethernet frame comprises generating the partial networking Ethernet based on information about the VLAN ID corresponding to the service ID information in a case of the network using a VLAN service.

10. The method of claim 8, wherein the generating of the partial networking Ethernet frame comprises generating the partial networking Ethernet based on information about the MPLS label corresponding to the service ID information in a case of the network using an MPLS service.

11. The method of claim 9, wherein the generating of the partial networking Ethernet frame comprises generating the partial networking Ethernet frame containing data including E-type data for indicating a type of frame, the VLAN ID for data forwarding and an operation instruction for an ECU.

12. The method of claim 10, wherein the generating of the partial networking Ethernet frame comprises generating the partial networking Ethernet frame containing data including E-type data for indicating a type of frame, the MPLS label for data forwarding and an operation instruction for an ECU.

13. An electronic control unit comprising the apparatus capable of providing partial networking support for a vehicle as claimed in claim 1.

14. An electronic control unit comprising the apparatus capable of providing partial networking support for a vehicle as claimed in claim 2.

15. An electronic control unit comprising the apparatus capable of providing partial networking support for a vehicle as claimed in claim 3.

16. An electronic control unit comprising the apparatus capable of providing partial networking support for a vehicle as claimed in claim 4.

17. An electronic control unit comprising the apparatus capable of providing partial networking support for a vehicle as claimed in claim 5.

18. An electronic control unit comprising the apparatus capable of providing partial networking support for a vehicle as claimed in claim 6.
